(19) United States
(12) Patent Application Publication
(10) Pub. No.: US 2005/0238241 A1
(43) Pub. Date: Oct. 27, 2005

(54) Image compression apparatus generating and using assistant images for deblocking processing and a method thereof

(75) Inventor: Jae-hoon Koo, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/087,696

(22) Filed: Mar. 24, 2005

(30) Foreign Application Priority Data
Apr. 23, 2004 (KR) 10-2004-0028079

(51) Int. Cl. G06K 9/36

(52) U.S. Cl. 382/232

(57) ABSTRACT

An image compression apparatus and method for producing and using an assistant image for deblocking processing. The image compression apparatus has an assistant image generation unit for generating an assistant image by using an original image, an image compression part for compressing the generated original image and assistant image, and a deblocking processing part for applying the deblocking processing to the compressed original image by using the compressed assistant image. Since the deblocking processing is carried out in the image compression process, the image compression apparatus can prevent the blocking artifacts even in cases where a consumer's product for decompressing and reproducing the compressed images is not a deblocking means. Further, the existing general image compression encoder can be used without change, and the reduced computation amounts necessary for the deblocking processing can result in reducing the processing load, increasing a processing rate, and reducing power consumption of the processor.

### CROSS-REFERENCE TO RELATED APPLICATIONS

This application claims the benefit under 35 U.S.C. § 119(a) of Korean Patent Application No. 10-2004-0028079, filed in the Korean Intellectual Property Office on Apr. 23, 2004, the entire contents of which are incorporated herein by reference.

### BACKGROUND OF THE INVENTION

1. Field of the Invention

The present invention relates to an image compression apparatus and a method thereof. More particularly, the present invention relates to an image compression apparatus for compressing and outputting input image data in a compression format, and an implementation method thereof.

2. Description of the Related Art

Image data comprises a very large amount of data as compared to text data. Therefore, a large amount of storage space is required for storage of image data, and a large amount of time is required for transfers of the image data.

Accordingly, in order to solve the above problems, image data compression technologies have been introduced, such as Joint Photographic Experts Group (JPEG), Moving Picture Experts Group (MPEG), H.261, H.264, and so on. With the use of such compression technologies, the amount of image data is remarkably reduced, and therefore, the data storage and transfers can be effectively carried out.

In general, such image compression is carried out by a one-chip encoder. FIG. 1 is a block diagram illustrating such a conventional image compression encoder.

The image compression encoder applies signal processing to input original images to compress and output the images in a predetermined format. In FIG. 1, the image compression encoder 10 has an image-dividing unit 11, a Discrete Cosine Transform (DCT) unit 13, a quantization unit 15, and a Huffman Coding unit 17.

An original image input into the image compression encoder 10 is divided by the image-dividing unit 11 into plural blocks. The DCT unit 13 applies the DCT to the respective divided blocks in order, the quantization unit 15 quantizes the blocks, and the Huffman Coding unit 17 then applies the Huffman Coding to the quantized blocks so that the original image is compressed.

As noted above, in order to compress an image, the input original image has to be divided into blocks, each having a certain size such as 8×8 pixels in general, and a compression process has to then be applied to the respective divided blocks.

However, the above process produces a phenomenon of discontinuities at every image block boundary when the compressed image is decompressed and reproduced. Such a phenomenon refers to the generation of discrete or discontinuous values at boundaries of the blocks that are divided when an image is compressed. As a result, when reproduced, the image is displayed like several pieces of tiles put together. Such a phenomenon comes up more remarkably at higher compression ratios.

Thus, a number of deblocking approaches have been proposed to eliminate such blocking artifacts.

A first deblocking approach is applied when an original image is compressed, and which applies a deblocking algorithm to quantized blocks. The first deblocking approach requires a component for applying the deblocking algorithm between the quantization unit 15 and the Huffman Coding unit 17. Thus, the image compression encoder 10 has to be re-designed, which causes a problem in that the existing image compression encoder 10 used in general can not be employed.

A second deblocking approach is to apply the Huffman decoding to the compressed image output from the image compression encoder 10, apply the deblocking algorithm, and then apply the Huffman coding again, so as to re-generate a compressed image. The second deblocking approach requires three additional tasks, that is, i) Huffman decoding, ii) deblocking algorithm application, and iii) Huffman coding, which causes problems resulting in the overload to the processor, lower processing rates, and increased power consumption due to the increased load to the processor.

A third deblocking approach is to decompress a compressed image and apply the deblocking algorithm. However, if a consumer's product does not carry out such an algorithm to decompress and reproduce the compressed image, a problem occurs in that the deblocking can not be carried out.

Thus, deblocking processing is required to be performed during the image compression processing and the processor must not have an excessive load upon performing the deblocking processing. It is further required that the existing general image compression encoder 10 has to be employed.

Accordingly, a need exists for a method and apparatus which can prevent the blocking artifacts and reduce the required processing loads and power consumption of the processor.

### SUMMARY OF THE INVENTION

The present invention has been developed in order to solve the above drawbacks and other problems associated with the conventional arrangement. An aspect of the present invention is to provide an image compression apparatus and method for generating an assistant image for an original image and then applying deblocking processing using the assistant image, upon the image compression by a general image compression encoder.

The foregoing and other objects and advantages are substantially realized by providing an image compression apparatus comprising an assistant image generation unit for generating an assistant image by using an original image, an image compression part for compressing the original image and the generated assistant image, and a deblocking processing part for applying deblocking processing to the compressed original image by using the compressed assistant image.

The assistant image generation unit can be further applied to divide the original image into plural blocks, estimate AC coefficients of the divided blocks by using DC coefficients of the divided blocks, and generate the assistant image.

The deblocking processing can be carried out by replacing predetermined coefficient information of the compressed original image with coefficient information corresponding to the compressed assistant image.

The coefficient information can include AC coefficient information, and the AC coefficient information can include a Huffman code with respect to the AC coefficients.

The foregoing and other objects and advantages are substantially realized by providing an image compression method comprising steps of a) generating an assistant image by using an original image, b) compressing the original image and the generated assistant image, and c) applying deblocking processing to the compressed original image by using the compressed assistant image.

The step (c) can further include steps of dividing the original image into plural blocks, calculating DC coefficients of the divided blocks, and estimating AC coefficients of the divided blocks by using the calculated DC coefficients.

The step (c) can further include steps of applying the deblocking processing by replacing predetermined coefficient information of the compressed original image with coefficient information corresponding to the compressed assistant image.

The coefficient information can include AC coefficient information, and the AC coefficient information can include a Huffman code with respect to the AC coefficients.

### BRIEF DESCRIPTION OF THE DRAWINGS

The above aspects and features of the present invention will become more apparent by describing certain embodiments of the present invention with reference to the accompanying drawings, in which:

FIG. 1 is a block diagram illustrating a conventional image compression encoder;

FIG. 2 is a block diagram illustrating an image compression apparatus for generating and using an assistant image for deblocking processing according to an embodiment of the present invention;

FIG. 3 is a flow chart for illustrating an image compression method for generating and using an assistant image for deblocking processing according to an embodiment of the present invention;

FIG. 4 is a flow chart for illustrating in detail an assistant image generation step of FIG. 3;

FIG. 5 is a view for illustrating an AC coefficient estimation step of FIG. 4; and

FIG. 6 is a block diagram for illustrating another embodiment of the assistant image generation unit for the assistant image generation of FIG. 2.

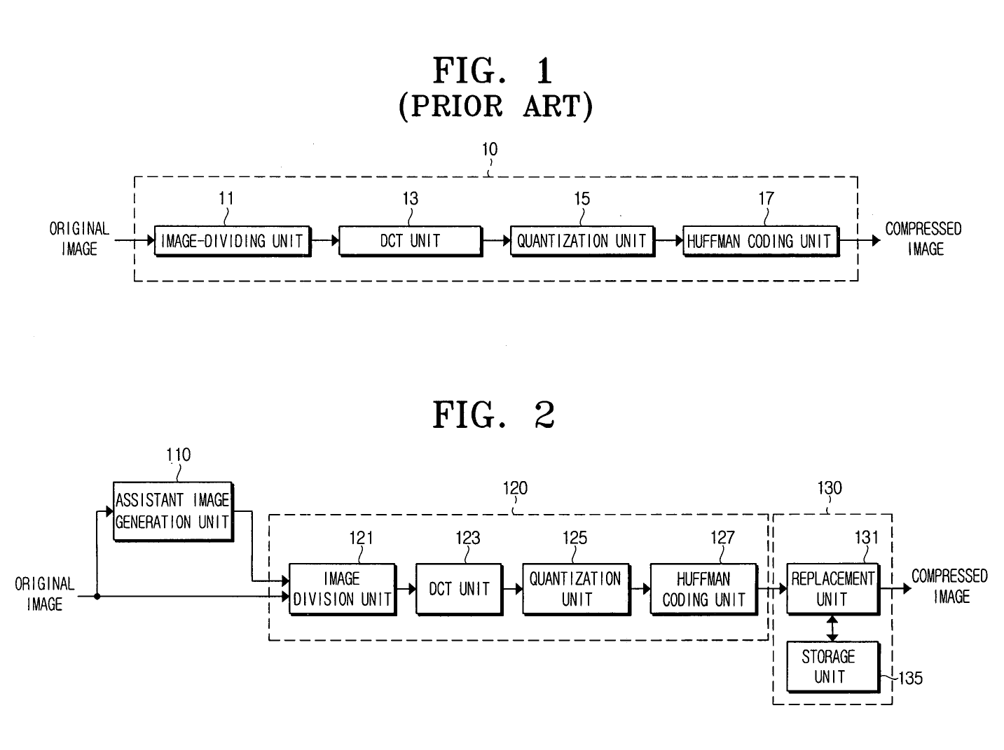

Throughout the drawings, like reference numerals will be understood to refer to like parts, components and structures.

### DETAILED DESCRIPTION OF EXEMPLARY EMBODIMENTS

Hereinafter, certain exemplary embodiments of the present invention will be described in detail with reference to the accompanying drawings.

In the following descriptions, same drawing reference numerals are used for the same elements even in different drawings. The matters defined in the descriptions, such as a detailed construction and element descriptions are provided to assist in a comprehensive understanding of the invention. Also, well-known functions or constructions are not described in detail since they would obscure the invention in unnecessary detail.

FIG. 2 is a block diagram for illustrating an image compression apparatus for generating and using an assistant image for deblocking processing. In FIG. 2, the image compression apparatus has an assistant image generation unit 110, an image compression part 120, and a deblocking processing part 130.

The assistant image generation unit 110 generates an assistant image by using an input original image. The original image refers to an image which is the compression target, that is, an image to be compressed. The assistant image refers to an image to be used for applying the deblocking processing to a compressed original image. The deblocking processing refers to the processing to be carried out in the compression step to eliminate the blocking artifacts that can be generated as compressed original images are decompressed.

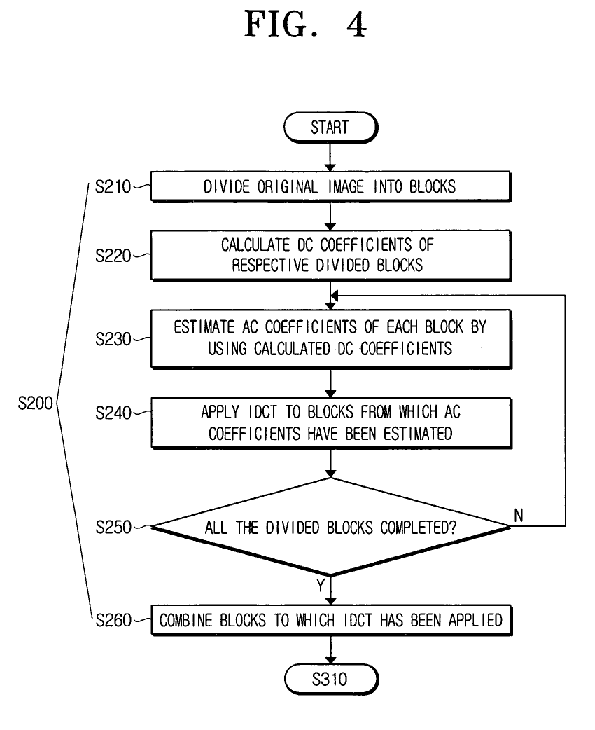

The assistant image generation unit 110 generates an assistant image by using a program created as a predetermined algorithm. An exemplary algorithm for generating the assistant image is shown in FIG. 4. A description of the algorithm of FIG. 4 is described in greater detail below.

Returning to FIG. 2, the image compression part 120 compresses in a predetermined format, an input original image and an assistant image generated from the assistant image generation unit 110. The compression format to be applied can be any suitable format, such as the JPEG, MPEG, H.261, or H.264 format. The image compression part 120 has an image division unit 121, a DCT unit 123, a quantization unit 125, and a Huffman coding unit 127.

The image division unit 121 divides an input image into square blocks, for example, blocks each having 8×8 pixels. The DCT unit 123 then applies the DCT to each of the divided blocks. The DCT application transforms the pixel values of the blocks into 1 DC coefficient and 63 AC coefficients.

The quantization unit 125 divides and rounds off the DC coefficient and AC coefficients according to quantization steps so as to eliminate the coefficients smaller than a standard value, thereby leaving only valid coefficients larger than the standard value. The Huffman coding unit 127 applies the Huffman coding to the valid coefficients remaining in the quantization process. Therefore, the Huffman coding unit 127 generates and outputs the Huffman code of DC coefficient (hereinafter, referred to as DC Huffman code) and the Huffman code of valid AC coefficients (hereinafter, referred to as AC Huffman code).

The deblocking processing part 130 applies the deblocking processing to a compressed original image output from the image compression part 120. The deblocking processing uses a compressed assistant image output from the image compression part 120. To achieve this, the deblocking processing part 130 comprises a replacement unit 131 and a storage unit 135.

The storage unit 135 is a buffer for storing a compressed original image.

The replacement unit 131 uses a compressed assistant image to apply the deblocking processing to the compressed original image stored in the storage unit 135. In detail, the replacement unit 131 replaces the AC Huffman code of the compressed original image with the AC Huffman code of an assistant image corresponding to the compressed original image. Further, a new compressed image is output that is finally generated through the replacement process of the AC Huffman code.

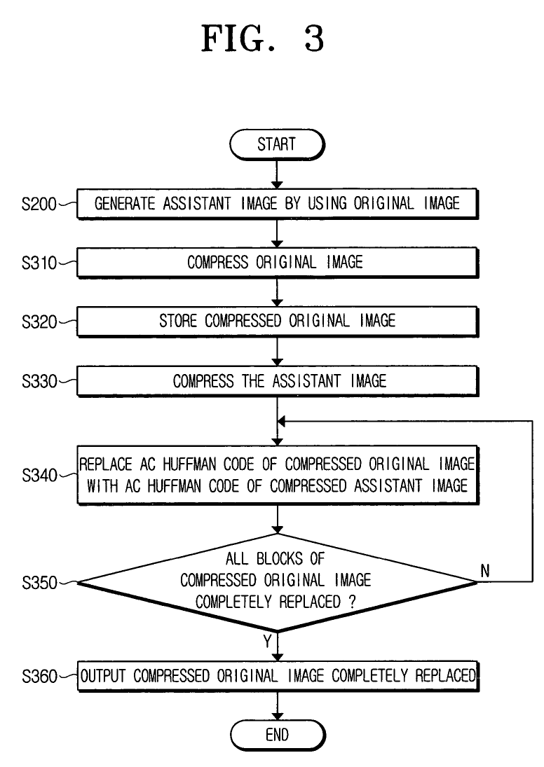

Hereinafter, a description will be made in greater detail of an image compression process performed by the image compression apparatus of FIG. 2 with reference to FIG. 3. FIG. 3 is a flow chart for illustrating an image compression method for generating and using an assistant image for the deblocking processing according to an embodiment of the present invention.

Referring to FIG. 3, an input original image is first used in order for an assistant image to be generated at step (S200). Hereinafter, a description will be made in greater detail of the assistant image generation step, that is, the step (S200), with reference to FIG. 4. FIG. 4 is a flow chart for illustrating the assistant image generation step (S200) in detail.

Referring to FIG. 4, the assistant image generation unit 110 divides an input original image into square blocks each having 8×8 pixels at step (S210), and computes a DC coefficient of each divided block at step (S220). The DC coefficient refers to an average pixel value of a block. Therefore, the number of the computed DC coefficients is the same as the number of the divided blocks.

The assistant image generation unit 110 then uses the computed DC coefficients to estimate the AC coefficients of the individual blocks at step (S230). One block has 63 AC coefficients in total, so 63 AC coefficients can be estimated. However, the estimation of all the AC coefficients can result in an overload, processing delays, or the like, due to the increase of computation amounts necessary therefor. Thus, the assistant image generation unit 110 can be implemented to estimate only the appropriate number of AC coefficients. The AC coefficients to be estimated are low-frequency AC coefficients containing the most image information.

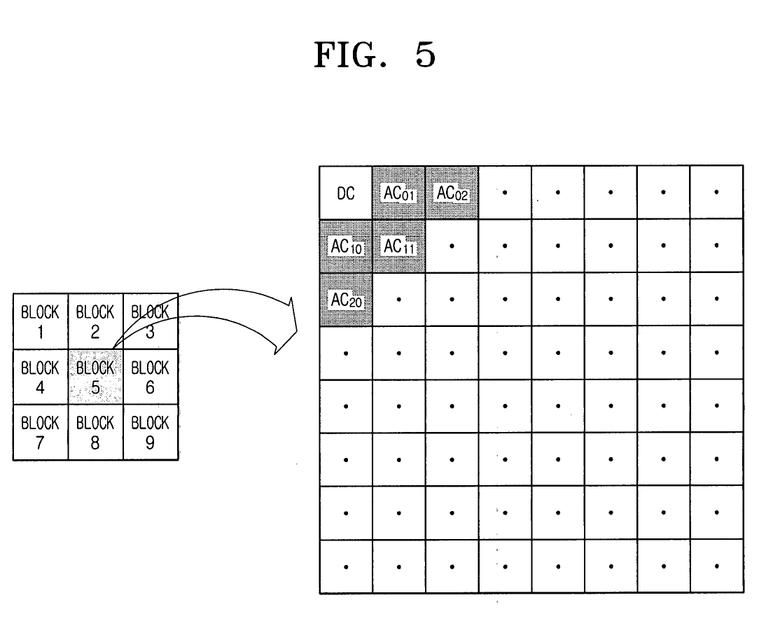

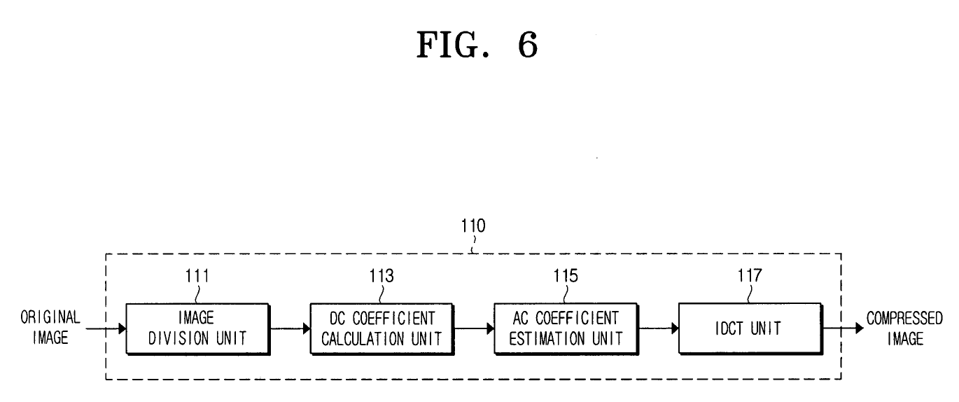

Hereinafter, a description will be made in greater detail of an AC coefficient estimation process of step (S230) with reference to FIG. 5. On the left side of FIG. 5, ‘block 5’ is shown as a shaded block that is enclosed by ‘block 1’ to ‘block 9’. On the right side of FIG. 5, AC coefficients are shown as shaded blocks that are to be estimated out of the AC coefficients of ‘block 5’. As shown in FIG. 5, the exemplary embodiment of the present invention shown is described as an example wherein only five low-frequency AC coefficients are estimated.

The shaded five AC coefficients AC₀₁, AC₁₀, AC₂₀, AC₁₁, and AC₀₂ resulting from ‘block 5’ can be estimated by using DC coefficients of ‘block 1’ to ‘block 9’ (with the exception of ‘block 5’). Wherein the DC coefficients of ‘block 1’ to ‘block 9’ (with the exception of ‘block 5’) are respectively referred to as ‘DC1’ to ‘DC9’, estimation equations can be expressed as in Equation (1) below, and are used for the estimations of AC coefficients AC₀₁, AC₁₀, AC₂₀, AC₁₁, and AC₀₂, respectively.
AC₀₁=1.13885(DC₄−DC₆)
AC₁₀=1.13885(DC₂−DC₈)
AC₂₀=0.27881(DC₂+DC₈−2DC₅)
AC₁₁=0.16213((DC₁−DC₃)−(DC₇−DC₉))
AC₀₂=0.27881(DC₁+DC₆−2DC₅) (1)

Referring to FIG. 4, once the estimation of the AC coefficients are completed, the assistant image generation unit 110 applies the inverse DCT (IDCT) to the blocks for which the AC coefficients have been estimated at step (S240).

The estimation step (S230) and the IDCT step (S240) are applied to each block. If the estimation and IDCT are completely applied to all the divided blocks at step (S250), the assistant image generation unit 110 combines and outputs the blocks to which the IDCT has been applied at step (S260).

The image produced and output through the above process becomes an assistant image. The important characteristics achieved in producing the assistant image is the estimate of the AC coefficients of each block by using the DC coefficients of the respective divided blocks, which is effective in preventing the blocking artifacts.

By referring to FIG. 3, a description will now be made of a process that will be carried out after the assistant image generation step (S200).

The image compression part 120 compresses and outputs an input original image in a predetermined format at step (S310), and the output compressed original image is temporarily stored in the storage unit 135 of the deblocking processing part 130 at step (S320). The compression process is a process of applying the Huffman coding to valid coefficients remaining through the division, DCT, and quantization of the original image. Thus, only the DC Huffman code and AC Huffman code of the compressed original image are output from the image compression part 120 and temporarily stored in the storage unit 135.

The image compression part 120 then compresses and outputs in a predetermined format, the assistant image produced from the assistant image generation unit 110 at step (S330). The image compression part 120 outputs the DC Huffman code and AC Huffman code of the compressed assistant image.

The replacement unit 131 then replaces the AC Huffman code of the compressed original image stored in the storage unit 135 with the AC Huffman code of the compressed assistant image at step (S340). The replacement process is carried out block by block. As shown in FIG. 5, five AC coefficients AC₀₁, AC₁₀, AC₂₀, AC₁₁, and AC₀₂ are estimated with respect to each block of the assistant image, and the remaining coefficients are treated as ‘0’. Thus, the Huffman code as to the five AC coefficients is the AC Huffman code of the compressed assistant image used for the replacement.

The replacement process of the step (S340) is carried out block by block, therefore, once the replacement process is completed with respect to all the blocks of the compressed original image at step (S350), the compressed original image that has been completely replaced and stored in the storage unit 135 is output at step (S360). The output image is the compressed image to which the deblocking processing has been applied.

As noted above, the assistant image generation unit 110 has been configured to generate an assistant image by using a program created through the algorithm of FIG. 4. In FIG. 5, the assistant image generation unit 110 computes 1 DC coefficient per block and estimates 5 AC coefficients, which requires less processing when considering that, in general, 64 coefficients are processed when the DCT and quantization are applied. Thus, the assistant image generation unit 110 has less required computation amounts, so it can be implemented through software applications.

However, in yet another embodiment of the present invention the assistant image generation unit 110 can be implemented as hardware, which is shown in FIG. 6.

Referring to the exemplary embodiment of FIG. 6, the assistant image generation unit 110 has an image division unit 111 for dividing an input original image into square blocks of 8×8 pixels, a DC coefficient calculation unit 113 for calculating the DC coefficients of the respective divided blocks, an AC coefficient estimation unit 115 for estimating the AC coefficients of the individual blocks using the calculated DC coefficients, and an IDCT 117 for applying the IDCT to the blocks for which the AC coefficients have been estimated.

The assistant image generated by the assistant image generation unit 110 shown in FIG. 6 is substantially the same as the assistant image generated by the process described as above.

As described above, the present invention can generate an assistant image for an original image and apply the deblocking processing by using the same when the original image is compressed. Since the deblocking processing is carried out in the image compression process, the present invention can prevent the blocking artifacts even in cases where a consumer's product for decompressing and reproducing the compressed images is not a deblocking means. Further, the present invention enables the existing general image compression encoder to be used without change, and can result in reducing the processing load, increasing a processing rate, and reducing power consumption of the processor due to less computation amounts required for the deblocking processing.

The foregoing embodiments and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. An image compression apparatus, comprising:
an assistant image generation unit for generating an assistant image by using an original image;
an image compression part for compressing the original image and the generated assistant image; and
a deblocking processing part for applying deblocking processing to the compressed original image by using the compressed assistant image.

2. The image compression apparatus as claimed in claim 1, wherein the assistant image generation unit is configured to divide the original image into plural blocks, estimate AC coefficients of the divided blocks by using DC coefficients of the divided blocks, and generate the assistant image.

3. The image compression apparatus as claimed in claim 1, wherein the deblocking processing part is configured to replace predetermined coefficient information of the compressed original image with coefficient information corresponding to the compressed assistant image.

4. The image compression apparatus as claimed in claim 3, wherein the coefficient information comprises AC coefficient information.

5. The image compression apparatus as claimed in claim 4, wherein the AC coefficient information comprises a Huffman code with respect to the AC coefficients.

6. An image compression method, comprising steps of:
generating an assistant image by using an original image;
compressing the original image and the generated assistant image; and
applying deblocking processing to the compressed original image by using the compressed assistant image.

7. The image compression method as claimed in claim 6, wherein the step of generating an assistant image comprises the steps of:
dividing the original image into plural blocks;
calculating DC coefficients of the divided blocks; and
estimating AC coefficients of the divided blocks by using the calculated DC coefficients.

8. The image compression method as claimed in claim 6, wherein the step of applying the deblocking processing comprises the step of:
replacing predetermined coefficient information of the compressed original image with coefficient information corresponding to the compressed assistant image.

9. The image compression method as claimed in claim 8, wherein the coefficient information comprises AC coefficient information.

10. The image compression method as claimed in claim 9, wherein the AC coefficient information comprises a Huffman code with respect to the AC coefficients.
